(19) United States
(12) Patent Application Publication
(10) Pub. No.: US 2014/0069948 A1
(43) Pub. Date: Mar. 13, 2014

(54) HANDGRIP FOR COOKING VESSELS

(71) Applicant: LA TERMOPLASTIC F.B.M. S.R.L., ARSAGO SEPRIO (VA) (IT)

(72) Inventor: MARCO MUNARI, CARDANO AL CAMPO (VA) (IT)

(73) Assignee: LA TERMOPLASTIC F.B.M. S.R.L., ARSAGO SEPRIO (VA) (IT)

(21) Appl. No.: 14/025,331

(22) Filed: Sep. 12, 2013

(30) Foreign Application Priority Data
Sep. 13, 2012 (IT) MI2012A 001512

(51) Int. Cl. A47J 36/00

(52) U.S. Cl. CPC A47J 36/00
USPC 220/755

(57) ABSTRACT

The invention describes a handgrip (10) for a cooking vessel, usable in particular as a knob of a lid (12). The handgrip (10) comprises a base element (14), able to be fixed to the lid (12) or to a wall of the cooking vessel, and a gripping element or handle (16), snap-coupled with such a base element (14). The gripping element or handle (16) is hinged with respect to the base element (14) and can rotate from a closed or folded configuration, in which such a gripping element or handle (16) rests on the base element (14) in order to allow the handgrip (10) to reduce its own size in height, to an open configuration, in which such a gripping element or handle (16) is raised according to a right angle with respect to the base element (14) and can be gripped in order to raise the lid (12) or the cooking vessel on which the handgrip (10) is applied.

The present invention refers to a handgrip for cooking vessels, usable in particular but not exclusively as a knob for the lid of a saucepan, a frying pan, a pot or similar articles.

As known, the most common vessels intended for cooking food in general, like for example frying pans, saucepans and pots, are provided with handles or handgrips that allow easy gripping, even when the vessel is full and hot. Should such vessels intended for cooking food be provided with a lid, the lid itself is also typically provided with a handgrip or knob that allows it to be gripped by the user.

The knob of a lid for cooking vessels usually consists of a coupling portion with the lid itself and a handgrip portion, which extends upwards from the coupling portion. Known knobs generally consist of monolithic bodies made from thermosetting polymeric materials, so as to ensure suitable heat insulation capabilities.

However, in order to be able to be gripped safely by the user and to avoid the user himself coming into contact with the surface of the lid, usually very hot, the handgrip portion of known knobs is normally voluminous and has overall dimensions in width and in height of the order of a few centimetres. Such dimensions consequently increase the overall bulk of the cooking vessel and of the relative lid, for example in the case of insertion onto shelves, in refrigerators, ovens or to take care of washing steps in dishwashers.

The purpose of the present invention is therefore to make a handgrip for cooking vessels, usable in particular but not exclusively as a knob for the lid of a saucepan, a frying pan, a pot or similar articles, which is able to solve the aforementioned drawback of the prior art in an extremely simple, cost-effective and particularly functional manner.

In detail, a purpose of the present invention is to make a handgrip for cooking vessels that is particularly compact and that allows the cooking vessel to be easily repositioned when not in use, limiting its bulk.

Another purpose of the present invention is to make a handgrip for cooking vessels that always ensures an adequate grip by the user.

A further purpose of the present invention is to make a handgrip for cooking vessels that ensures the heat insulation of such a handgrip with respect to the vessel on which it is applied.

These purposes according to the present invention are accomplished by making a handgrip for cooking vessels, useable in particular but not exclusively as a knob for the lid of a saucepan, a frying pan, a pot or similar articles, as outlined in claim 1.

Further characteristics of the invention are highlighted by the dependent claims, which are an integral part of the present description.

The characteristics and advantages of a handgrip for cooking vessels according to the present invention will become clearer from the following description, given as a non-limiting example, referring to the attached schematic drawings, in which:

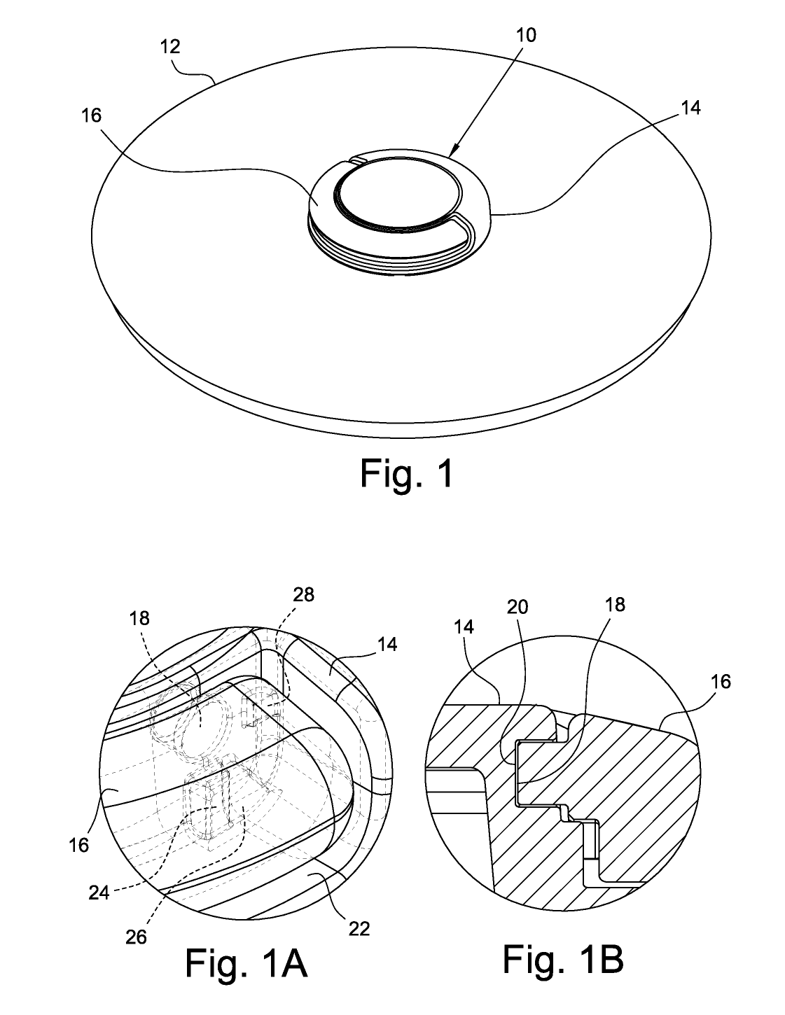

FIG. 1 is a perspective view of a preferred embodiment of the handgrip for cooking vessels according to the present invention, shown in rest or non-use configuration;

FIG. 1A is a transparent view of a detail of the handgrip for cooking vessels in the configuration of FIG. 1;

FIG. 1B is a section view of a detail of the handgrip for cooking vessels in the configuration of FIG. 1;

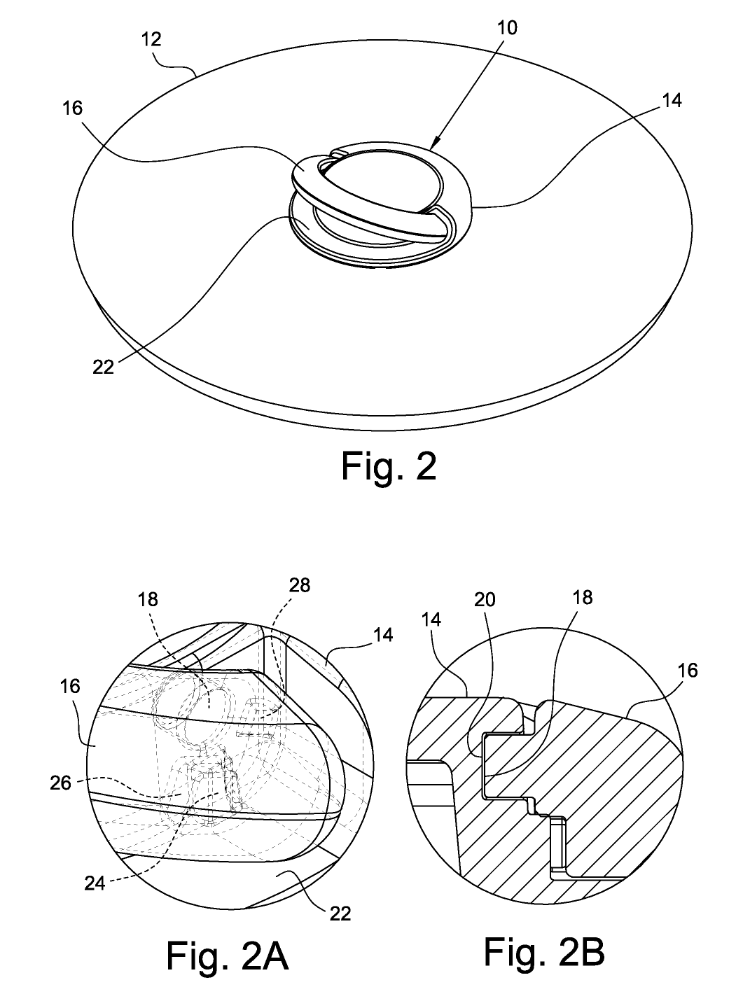

FIG. 2 is a perspective view of the handgrip for cooking vessels of FIG. 1, shown in an intermediate configuration between the rest or non-use one and that of use;

FIG. 2A is a transparent view of a detail of the handgrip for cooking vessels in the configuration of FIG. 2;

FIG. 2B is a section view of a detail of the handgrip for cooking vessels in the configuration of FIG. 2;

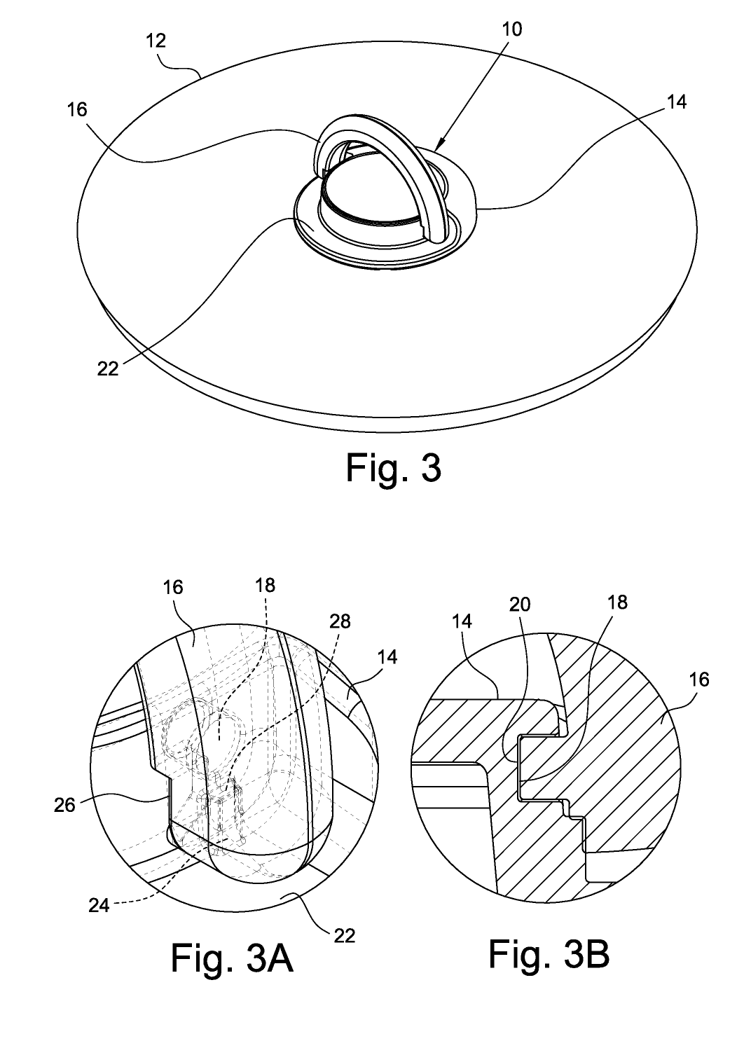

FIG. 3 is a perspective view of the handgrip for cooking vessels of FIG. 1, shown in use configuration;

FIG. 3A is a transparent view of a detail of the handgrip for cooking vessels in the configuration of FIG. 3;

FIG. 3B is a section view of a detail of the handgrip for cooking vessels in the configuration of FIG. 3;

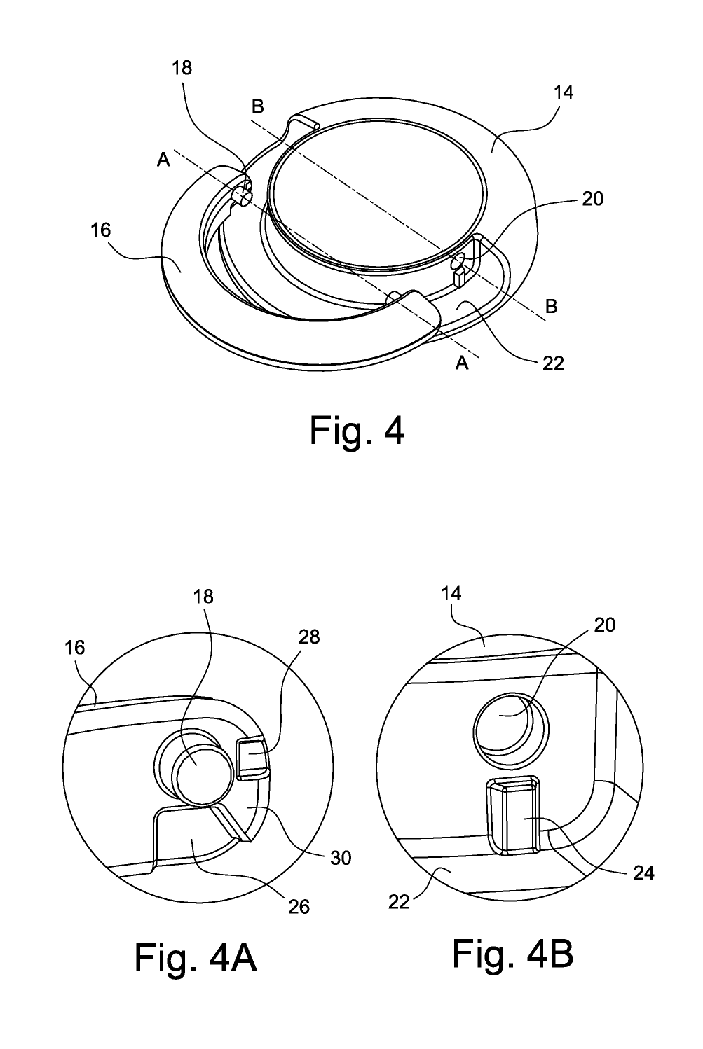

FIG. 4 is an exploded perspective view of the handgrip for cooking vessels of FIG. 1;

FIG. 4A is a detailed view of a detail of the handgrip for cooking vessels visible in FIG. 4; and

FIG. 4B is another detailed view of a detail of the handgrip for cooking vessels visible in FIG. 4.

With reference to the figures, a handgrip for cooking vessels according to the present invention is shown, wholly indicated with reference numeral 10. The handgrip 10 is preferably configured to be applied to the lid 12 of a generic cooking vessel, like for example a saucepan, a frying pan, a pot or similar articles.

The handgrip 10 is of the type comprising a base element 14, able to be fixed in a per se known way to the lid 12 or to a wall of any cooking vessel, and a gripping element or handle 16, snap-coupled with such a base element 14. The handle 16 is hinged with respect to the base element 14 and can rotate from a closed or folded configuration, in which such a handle 16 rests on the base element 14 in order to allow the handgrip 10 to reduce its own size in height (FIG. 1), to an open configuration, in which such a handle 16 is raised according to a right angle with respect to the base element 14 and can be gripped to raise the lid 12 or the cooking vessel on which the handgrip 10 is applied (FIG. 3).

In particular, the base element 14 consists of a monolithic body, preferably manufactured with a thermosetting polymeric material, for example in phenolic resin like Bakelite, and it is preferably disk-shaped. The handle 16 also consists of a monolithic body, preferably manufactured with a thermoplastic polymeric material, for example in synthetic polyamide like nylon, and it is preferably arc-shaped of circumference, more specifically shaped like a half-circumference.

However, this does not rule out that the handle 16 can take up other shapes suitable for the purpose, like for example semi-elliptical or a generic open polygon shape. Consequently, the base element 14, instead of being disk-shaped, can also take up any other shape corresponding to the shape of the handle 16.

Based on the preferred embodiment shown in the figures, the half-circumference shaped handle 16 is provided, at its opposite ends, with two symmetrical pins 18 oriented along a first axis A-A (FIG. 4). The two pins 18 of the handle 16 insert into corresponding blind holes 20 formed on opposite portions of the base element 14 and also oriented along a second axis B-B, so as to ensure the rotary movement, about a single axis obtained by superimposing the axes A-A and B-B, of the handle 16 with respect to the base element 14.

The base element 14 of the handgrip 10 is provided with a grooved portion 22, substantially shaped like a half-circumference or in general like any other shape corresponding to the shape of the handle 16, in which such a handle 16 is inserted in a shape coupling configuration when it is in its closed or folded configuration, so that the entire handgrip 10 can occupy as little space as possible in such a closed or folded configuration of the handle 16.

Preferably, the base element 14 is provided, at each of the blind holes 20, with a respective block tooth 24 (FIG. 4B). Each block tooth 24 is configured so as to cooperate with one or more cavities 26, 28 formed at the pins 18 of the handle 16 (FIG. 4A) in order to facilitate its movement while passing from its closed or folded configuration to its open configuration and vice-versa, and/or to maintain the handle 16 stably firm in its open configuration.

In detail, at each pin 18 of the handle 16 a first rotation cavity 26 is formed having an elongated shape, in which the respective block tooth 24 of the base element 14 is housed when the handle 16 is in its closed or folded configuration (FIG. 1A) and in which such a block tooth 24 slides during the rotation of the handle 16 itself from its closed or folded configuration to its open configuration (FIG. 2A). At each pin 18 of the handle 16 a second retainer cavity 28 is also formed, having a shape substantially identical to the shape of the respective block tooth 24, in which such a block tooth 24 stably inserts to maintain the handle 16 stably firm in its open configuration (FIG. 3A).

Between the first rotation cavity 26 and the second retainer cavity 28 formed on the same end of the handle 16 a protruding portion 30 is interposed (FIG. 4A). In order to obtain the rotation of the handle 16 from its closed or folded configuration to its open configuration there must therefore be a slight elastic deformation of such a handle 16, so that the block tooth 24 passes from the first rotation cavity 26 to the second retainer cavity 28, passing beyond the protruding portion 30. Vice-versa, in order to obtain the rotation of the handle 16 from its open configuration to its closed or folded configuration there must be an analogous slight elastic deformation of such a handle 16, so that the block tooth 24 passes from the second retainer cavity 28 to the first rotation cavity 26, passing beyond the protruding portion 30 once again.

It has thus been seen that the handgrip for cooking vessels according to the present invention achieves the purposes outlined earlier, being particularly compact in its closed or folded configuration and ensuring safety and easy gripping in its open configuration.

The handgrip for cooking vessels of the present invention thus conceived can in any case undergo numerous modifications and variants, all of which are covered by the same inventive concept; moreover, all of the details can be replaced by technically equivalent elements. In practice, the materials used, as well as the shapes and sizes, can be whatever according to the technical requirements.

The scope of protection of the invention is therefore defined by the attached claims.

1. Handgrip (10) for a cooking vessel, usable in particular as a knob of a lid (12), comprising a base element (14), to be fixed to said lid (12) or to a wall of said cooking vessel, and a gripping element or handle (16), snap-coupled with said base element (14), the handgrip (10) being characterized in that said gripping element or handle (16) is hinged with respect to the base element (14) and can rotate from a closed or folded configuration, wherein said gripping element or handle (16) rests on the base element (14) in order to allow the handgrip (10) to reduce its own size in height, to an open configuration, wherein said gripping element or handle (16) is raised according to a right angle with respect to the base element (14) and can be gripped in order to raise the lid (12) or the cooking vessel whereon the handgrip (10) is applied.

2. Handgrip (10) according to claim 1, characterized in that the base element (14) is provided with a grooved portion (22), having substantially a shape corresponding to the shape of the gripping element or handle (16), into which said gripping element or handle (16) is inserted in a shape-coupling configuration when it is in its closed or folded configuration, so that the whole handgrip (10) can occupy as little space as possible in said closed or folded configuration of the gripping element or handle (16).

3. Handgrip (10) according to claim 1, characterized in that the gripping element or handle (16) is provided, at its opposite ends, with two symmetrical pins (18) oriented along a first axis (A-A), said two pins (18) being inserted in corresponding blind holes (20) obtained on opposite portions of the base element (14) and oriented along a second axis (B-B), so as to ensure the rotary movement, about a single axis obtained by superimposing said first axis (A-A) and second axis (B-B), of said gripping element or handle (16) with respect to the base element (14).

4. Handgrip (10) according to claim 3, characterized in that the base element (14) is provided, at each of said blind holes (20), with a respective block tooth (24) configured so as to cooperate with one or more cavities (26, 28) obtained at the pins (18) of the gripping element or handle (16) in order to facilitate its movement while passing from its closed or folded configuration to its open configuration and vice versa, and/or to maintain said gripping element or handle (16) stably firm in its open configuration.

5. Handgrip (10) according to claim 4, characterized in that at each of the pins (18) of the gripping element or handle (16) a first rotation cavity (26) having an elongated shape is obtained, inside which the respective block tooth (24) of the base element (14) is housed when said gripping element or handle (16) is in its closed or folded configuration and inside which said block tooth (24) slides during the rotation of said gripping element or handle (16) from its closed or folded configuration to its open configuration.

6. Handgrip (10) according to claim 5, characterized in that at each of the pins (18) of the gripping element or handle (16) a second retainer cavity (28) is additionally obtained, which has a shape substantially identical to the shape of the respective block tooth (24) and into which said block tooth (24) stably inserts in order to keep said gripping element or handle (16) stably firm in its open configuration.

7. Handgrip (10) according to claim 6, characterized in that between the first rotation cavity (26) and the second retainer cavity (28) obtained on the same end of the gripping element or handle (16) a protruding portion (30) is interposed, in order to obtain the rotation of said gripping element or handle (16) from its closed or folded configuration to its open configuration an elastic deformation of said gripping element or handle (16) having to occur, so that the block tooth (24) passes from the first rotation cavity (26) to the second retainer cavity (28), passing beyond the protruding portion (30), whereas in order to obtain the rotation of said gripping element or handle (16) from its open configuration to its closed or folded configuration a similar elastic deformation of said gripping element or handle (16) having to occur, so that the block tooth (24) passes from the second retainer cavity (28) to the first rotation cavity (26), passing beyond the protruding portion (30) once again.

8. Handgrip (10) according to claim 1, characterized in that the base element (14) is made of a monolithic body manufactured in a thermosetting polymeric material and is disk-shaped, and in that the gripping element or handle (16) is made of a monolithic body manufactured in a thermoplastic polymeric material and is semicircle-shaped.

9. Handgrip (10) according to claim 8, characterized in that the base element (14) is manufactured in phenolic resin and the gripping element or handle (16) is manufactured in synthetic polyamide.

10. Handgrip (10) according to claim 9, characterized in that said phenolic resin is Bakelite and in that said synthetic polyamide is nylon.
